(19) United States
(12) Patent Application Publication
(10) Pub. No.: US 2006/0076705 A1
(43) Pub. Date: Apr. 13, 2006

(54) Multiple extruder assembly and process for continuous reactive extrusion

(76) Inventors: J. Nicholas Fowler, Odessa, TX (US); John J. DeCair, Odessa, TX (US); Shrikant V. Phadke, Odessa, TX (US)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 11/047,472

(22) Filed: Jan. 31, 2005

Related U.S. Application Data
(60) Provisional application No. 60/617,548, filed on Oct. 11, 2004.

(51) Int. Cl. B29C 47/38; B29C 47/60

(52) U.S. Cl. 264/211.23; 425/131.1

(57) ABSTRACT

Methods are disclosed for a novel and useful single pass extrusion process for the reactive extrusion and compounding of polymers. Traditional extruders utilized in reactive processes are of length to diameter ratios ranging from 30 to 1 to as high as 56 to 1. The process disclosed uses a series of sequential, very closely-coupled, independently driven screw extruders having a total effective length to diameter ratio much greater than 70 to 1 and as high as 132 to 1 or greater, and providing greatly extended reaction times, separate and multiple introductions of reactive and non-reactive agents and mechanical connections allowing for convenient screw changes and differential thermal expansion. The assembly is employed to economically produce grafted polyolefins, produce ionomers without employing the use of strong caustic agents, remove large volumes of unwanted polymer processing solvents and produce other reacted polymer species in one continuous pass.

### CROSS REFERENCE TO RELATED APPLICATIONS:

This application claims the benefit under 35 U.S.C. 119(e) of U.S. Provisional Patent Application Ser. No. 60/617,548 filed Oct. 11, 2004, and entitled: “Method and Apparatus for Reactive Extrusion Using a Dual Extruder Assembly of High Effective Length-to-Diameter Ratio” the disclosure of which is hereby incorporated by reference in its entirety. This application is also related to a PCT application filed of even date herewith and entitled “Continuous Extrusion Process for Producing Grafted Polymers” by J. Nicholas Fowler, et al. The disclosure of this PCT application is also hereby incorporated by reference in its entirety.

### BACKGROUND OF THE INVENTION

1. Field of the Invention

The present invention relates to a method and apparatus for continuously producing complex polymer compounds and reactively modified polymers in a melt phase. Compounding and reactive extrusion of polymers is a well known method for producing a wide variety of modified plastic materials including grafted polymers, ionomers, polyesters, thermoplastic elastomers, and polyurethanes. Typically, reactive extruders are comprised of single or double screw shaft assemblies rotated within an externally heated and cooled barrel and configured with various screw flight designs for feeding, melting, conveying, shearing, mixing and de-volatizing a viscous polymer fluid. Base polymers are introduced in a solid state into the feed zone of the melt extruder and subjected to shear stresses and conductive heating to produce a melt or fluid polymer. Required heating to produce a fluid or melt state differs with each polymer, but typically ranges between 130 degrees Celsius for waxes and soft polyolefins to greater than 250 degrees Celsius for some engineered thermoplastics. Reactive agents are then introduced and mixed into the molten polymer, and the polymer and agent are conveyed and stirred through a portion of the extruder to allow for the temperature and time dependent reactions to proceed. Volatiles, including un-reacted agents, agents originally contained in the base polymer and/or un-desired by-products of the reactions can then be stripped from the post reaction polymer melt. The newly reacted polymer then exits the extruder and is converted to a cooled state in a manner suitable for storage and shipping. The new, post-reaction polymer can then be additionally compounded discontinuously in a separate extrusion compounding step to add various non-reactive agents or fillers to impart cost advantages, reactive agent dilution, or modified polymer physical properties.

2. Description of Related Art

Prior art details the use of the numerous plastic extruders as devices for the reactive processing of polymers. The prior art includes the use of both individual single-screw extruders and individual co-rotating and counter-rotating twin-screw extruders with non-intermeshing, partially-intermeshing and fully intermeshing screw assemblies. Such individual extruder assemblies are widely employed for the reactive grafting of maleic anhydride and other di-carboxylic acid anhydrides to polyolefins, grafting silanes to polyolefins, adding and reacting various cross-linking chemicals to thermo-plastics, neutralization of acid co-polymers using metallic bases, grafting acrylic acid to polyolefins, esterification of acid copolymers, de-volatilization of polymers and various other reactive processes.

The configuration and total length of the reactive extruder is determined by the nature and number of reaction steps required and the time required for each reactive or non-reactive step performed. As individual or cumulative reaction times increase, the extruder can be lengthened allowing for longer residence time in the extruder, the extruder can be rotated more slowly also allowing for longer residence time in the extruder, and/or the extruder temperatures can be increased to hasten the reaction.

Lengthening the extruder longitudinally to increase residence time or to fit more reactions into an extruder must be accomplished without a proportional increase in screw diameter. The lengthening of the screw shaft(s) and maintaining a constant length to diameter ratio, L/D, does not increase residence time or longitudinal space for multiple reactive events. However, increasing shaft length and maintaining a constant shaft diameter produce increased instability of the free shaft ends and creates a potential over-torque condition of the driven shaft end.

Free end shaft instability requires screw designs that incorporate support of the shaft end(s) that in turn can interfere with the process design, often developing excessive shear in the polymer during the final stages of the reaction processes. Not incorporating screw designs that account for the flexibility of the free shaft ends increases shaft wear, increases extruder barrel wear and can ultimately cause catastrophic extruder failure from torsional shaft buckling or resultant shaft torsion failure.

The residence time in a reactive extruder can be increased by reducing the rpm's of the extruder shaft(s). However, if the rpm's of the extruder are slowed to increase residence time and the feed rate is held constant, the extruder shaft torque increases. All extruder shafts have a torque limit based on shaft diameter, and torque is a direct function of shaft length, feed rate and shaft rpm. The feed rate can be decreased to lower torque, but this leads to a proportional decrease in extruder productivity.

Reducing the extruder shaft revolutions per minute also reduces the efficiency of the dispersive and distributive mixing between the polymer and the reactive agents. With polymer melt systems consisting of high viscosity fluids, uniform reactive conversion of the base polymer during the reaction phase requires thorough and consistent mixing of both the polymer phase and the reactive agents throughout the extruder. As the screw shaft angular velocity decreases, more mixing elements are required on the screw design to maintain the equivalent mixing effect of higher screw speeds. Therefore, reducing the extruder shaft revolutions per minute reduces mixing and mass transfer in reactive and non-reactive zones, and requires the use of additional mixing zones and thus longer extruders to achieve equivalent performance of higher rpm operations.

Reactive extrusion, like all chemical reactions, is a temperature and time dependent conversion. The reactions require sufficient time and energy to melt the polymer and to mix the reactive agents into the highly viscous polymer melt. Sufficient time and energy is required for the desired reactions to proceed toward completion and to remove any un-desired by-products or un-reacted materials. The required energy input into the polymer is achieved by applying controlled electric, hot oil or steam heating to the barrels of the extruder and by frictional forces created within the polymer. These frictional forces are produced in specifically designed stirring and shearing zones of the extruder. The energy for shear heating is in turn controlled by screw design and extruder shaft torque supplied by a suitably geared electric motor coupled to the extruder shafts. If necessary, cooling of the polymer is achieved by cooling appropriate portions of the extruder barrel with air or tempered water systems incorporated into the extruder barrel.

It is well understood that chemical reaction rates are directly affected by temperature, as heating accelerates the reaction. Increasing the heat in the reactive extruder decreases reaction time and increases productive output of the extruder assembly. However, it is likewise well understood that heating of polymers and reactive agents also leads to many undesirable and concurrent side reactions. These include degradation of the base polymer; degradation of the reactive agents, side reactions of degraded reactive agents and degradation of the newly reacted polymer species. The longer the polymers and reactive agents are maintained at elevated temperatures, the greater the occurrence of these un-desirable side reactions. Increasing the reaction temperatures to accelerate the reaction and thus overcome insufficient extruder length, thus results in increased polymer degradation and side reactions that reduce final product quality. Reducing the temperatures in the extruder to reduce the un-desirable side reactions and polymer degradation also reduces the rate of the preferred reactions and requires the reaction time to necessarily be extended.

Extruder temperature also creates thermal expansion of the extruder barrel and screw shaft(s). Extruder temperatures can range from ambient of 10° C. to greater than 400° C. The axial expansion of the extruder shaft and barrel can exceed 0.0000124 m/m-° K. in a steel extruder. This is an expansion of 20 mm over the length of a 4,048 mm extruder for a temperature change of 390° C. Failure to allow for this linear barrel expansion can create stresses beyond the failure point of the machine parts.

Multiple or slow reactions can be accommodated in reactive extrusion through the use of multiple, independent extruders that feed one another in daisy chain or serial fashion. The current art allows for several multiple extruder assembly configurations.

Two extruders can be coupled together if the two extruders each are rigidly attached to independent bases and if the first extruder base is allowed to ride on wheels or bearings. The barrels of the extruders are rigidly attached, connecting the output of the first extruder barrel to the input of the second extruder barrel. The liner expansion of the first extruder barrel pushes the entire first machine base and extruder away from the point of attachment of the two extruder barrels. This is practical only if the movement of the first machine can always be kept free. This becomes increasingly difficult for extruders of large size and machines that undergo expansion and contraction on a frequent basis.

Extruders can be coupled in serial fashion through flexible piping or hoses. However, this design creates a polymer flow region that is unstirred by the extruder screw flights. The polymer adjacent to the heated pipe or hose surface is subject to increased degradation and subsequent formation of gels or large cross-linked bodies within the polymer melt. Continued heating of sensitive polymers may eventually produce char or completely degraded polymer and thus contaminate the polymer stream.

U.S. Pat. No. 3,536,680 describes the reactive polymerization in a single pass extrusion of styrene and other co-monomers that are liquid at room temperature. The reaction is conducted in an extrusion device consisting of three twin-screw extruders of differing inner diameters and rigidly connected to one another at right angles. No allowance is made for expansion of the connected extruders, and it is impossible by this method to accommodate long or heavy extruder devices. It is also impossible by this method to quickly remove the screw assemblies from the extruder barrels, as vertical disassembly of the extruder barrels along the horizontal axis is required.

U.S. Pat. No. 4,134,714 teaches a method for connecting a multi-stage extruder apparatus utilizing a rigid side connection of the two extruders, but without mixing in the connection zone.

U.S. Pat. No. 4,212,543 describes a series of cascading twin-screw extruders connected atop one another and coupled via a rigid, un-stirred connection port. No accommodation is made for differential expansion between the extruder barrels and the rigid connection, nor is allowance made for the differential expansion of the various extruder barrels and the drive assemblies.

U.S. Pat. No. 4,863,653 describes a non-reactive, multiple extruder assembly wherein the two extruders are serially connected via a pipe. The polymer flow in this pipe is conveyed in plug fashion and without the benefit of stirring or mixing.

U.S. Pat. No. 5,165,941 teaches a non-reactive multiple extruder apparatus for compounding non-reactive materials with polymer and utilizing two extruders to effect different shear rates in each machine. The disclosed process however includes regions of polymer flow that are un-stirred.

U.S. Pat. No. 5,424,367 describes a continuous, single pass, reactive extrusion process for multiple reactions on a single extruder of length to diameter ratio of up to 66 to 1. The key feature of the disclosed process is the removal of impurities from one reaction zone before a subsequent reaction is initiated in the extruder. The process disclosed is physically limited by the number of sequential reactions and stripping operations that can be performed on a single extruder apparatus. The process also describes utilizing a multiple extruder configuration, wherein the first extruder is not physically attached to the second extruder. The polymer output from the first extruder passes as a ribbon of molten material through the space between the two discontinuous machines.

Therefore it is desired to construct a multiple extruder assembly to provide for numerous reaction steps or reactions requiring extended time without concerns for shaft torque capacity or having to resort to lowered rpm's, lower feed rates or increased operating temperatures. It is further desired to connect multiple extruders sequentially so as to always maintain the polymer melt in a totally contained, controlled and stirred state and provide for the thermal expansion of the individual extruder barrels and shafts for machines of any size. It is also desired to construct such an extruder assembly that allows for independent rpm ranges in each extruder and eliminates any gaps between machine polymer flow streams.

It is thus the principle object of this invention to provide a multiple extruder assembly that creates a very high length to diameter ratio, is continuous in flow pattern with no unstirred and no un-contained regions, allows for independent drive of each machine, is easily modified and cleaned and allows for thermal expansion of each machine barrel and shaft assembly. Another object of this invention is to provide an economical and practical means of preparing graft functionalized polymers with low gel formation and tailored levels of polymer molecular weight reduction. Another object of this invention is to economically produce graft functionalized polymers with modified polymer molecular weight and with amine modification. Another object of this invention is to provide a means of preparing low gel content neutralized acid co-polymers without the use of strong caustics or exotic metal alloys as materials of construction. Another object of this invention is to provide a means to remove large quantities of volatiles from polymer melt streams. Another object of this invention is to provide a multiple extruder assembly with sufficient length to perform more than one of these processes sequentially or repeatedly and in one continuous pass.

### SUMMARY OF THE INVENTION

The invention relates to a unique assembly of extrusion equipment and the use of said assembly in the continuous production of various reacted and compounded polymers in a multiple stage extrusion reactor. It comprises a series of directly connected polymer extruders serially attached and constructed such that the discharge of each extruder proceeds directly into the feed region of a sequentially connected extruder and there exists no region of the process wherein the polymer is not in a continuously stirred condition. Additionally, there is no portion of polymer flow path that is not contained within the extruder. In this fashion, the melted polymer can be subjected to pressure, vacuum, mixing, conveying, reacting and/or reactant or non-reactant additions and or removal throughout the length of all so connected extruders. Likewise, no portion of the polymer melt phase is needlessly exposed to the atmosphere or requiring an inert gas blanket at the junction of any two extruders. The extruder assembly described herein is a unique family of extruder barrel mountings and connection transitions between sequential extruders. These connections and transitions accommodate the thermal expansion of the extruder barrel and screw shaft while maintaining a continuous flow path for the polymer without requiring the movement of an entire extruder and its complement gear drive, motor and base plate on wheels or bearings.

The polymer flow path is at all times in a stirred condition and contained within the walls of the extruder to allow for continuous reactive and physical processes including grafting, fuctionalization, neutralization, heating, cooling, injection, solid inclusion, pressure, vacuum and volatile removal. A particularly beneficial aspect of the multiple extruder assembly disclosed herein is that extruder screw removal for cleaning or changing may be accomplished with no additional effort than that required with conventional extruders.

The unique extruder assembly and connections can provide for two, three, four or more serially connected extruders. Each extruder of the combined assembly is driven by independent motors and gear reduction equipment. Thus, each extruder is capable of different revolutions per minute, shear rates and residence times. The assembly is specifically suited for the reactive extrusion of grafted polymers, viscosity modification, polymer neutralization, post-reactor polymerization and cross-linking, vacuum stripping, agent addition and multiple combinations of these.

### BRIEF DESCRIPTION OF DRAWINGS

FIG. 1 is an isometric and exploded view of a 3 extruder assembly according to one embodiment of the invention.

FIG. 2 is a partially cut-away, top plan view of the embodiment illustrated in FIG. 1.

FIG. 3 is a partially cut-away side elevation taken along the line indicated in FIG. 2.

FIG. 4 is a partially cut-away top plan view of a junction device according to one embodiment of the invention at ambient temperature.

FIG. 5 shows the embodiment of FIG. 4 at operating temperature.

FIG. 6 shows three different embodiments of extruder barrel supports according to the invention.

FIG. 7 is a partially cut-away top plan view of an alternative embodiment of the invention.

FIG. 8 is a partially cut-away side elevation of the embodiment of FIG. 7 along the line shown therein.

FIG. 9 is a partially exploded, isometric view of a 3 extruder assembly according to an alternative embodiment of the invention.

FIG. 10 is a block diagram of the reactor conditions employed in Example 1.

FIG. 11 is a block diagram of the reactor conditions employed in Example 2.

FIG. 12 is a block diagram of the reactor conditions employed in Example 3.

FIG. 13 is a block diagram of the reactor conditions employed in Example 4.

FIG. 14 is a block diagram of the reactor conditions employed in Example 5.

FIG. 15 is a block diagram of the reactor conditions employed in Example 6.

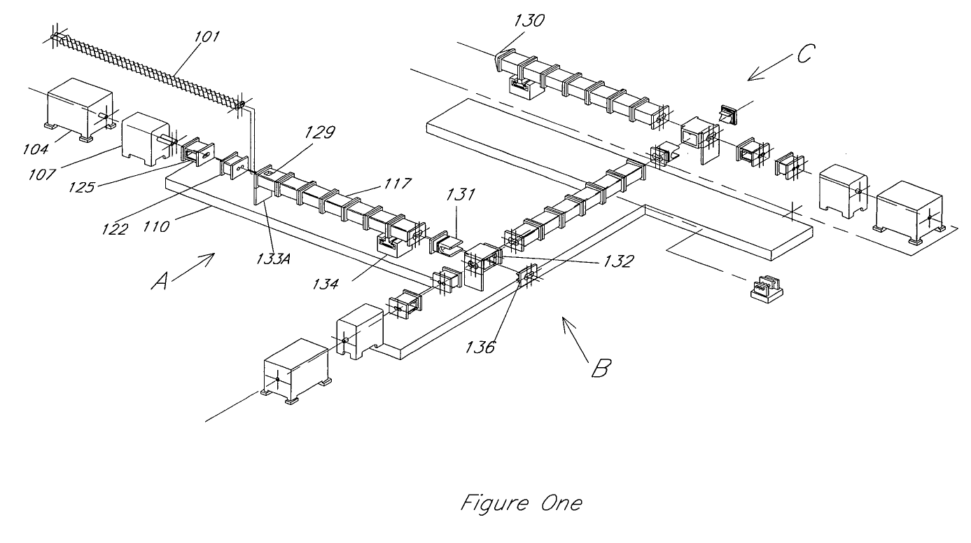

### DETAILED DESCRIPTION OF THE INVENTION

Referring to Figure One, three extruders “A”, “B”, and “C” are shown in isometric and expanded fashion to indicate the relative assembly and specific parts: drive motor 104, gear reduction unit 107, lantern section 3, seal housing 4, base pad 110, rigid support 133A, slide support 134, screw assembly 101, screw barrel 117, feed port 129, piston 131, piston housing 132, piston cap 136 and final outlet 130. Polymer flow is from the feed port 129 to the final outlet 130 sequentially passing through each extruder “A” to “B” to “C” via the connection at the piston housings.

Referring to Figure Two, the partial cut away, plan view of Figure One, the three twin screw extruders “A”, “B” and “C” are directly coupled sequentially together as to provide a total length to diameter ratio that is the sum of each individual machine length to diameter ratio. Each individual extruder is aligned so as the longitudinal axes of each pair of screw shafts 101, 102, and 103 are substantially co-planer and perpendicular with one another. Each extruder is driven by independent motors 104, 105, and 106 and gear reduction units 107, 108 and 109 that are in turn all rigidly attached to and supported on a common base plate or pad 110. The gear reduction unit output shafts 111, 112 and 113 are rigidly connected to the driven end or input end of the extruder shaft pairs.

The compounding extruders each have a barrel or housing 117, 118 and 119 within which is contained the screw shaft pairs 101, 102 and 103 extending from the inlet and driven end to the outlet end or discharge of the individual extruder. The shaft lengths are selected such that on heating each from ambient to the required operating temperatures, the individual shafts expand longitudinally and extend just to but not intersecting with the flights of the sequential extruder shaft flights.

The driven ends of the shafts of each downstream extruder housing enter the extruder barrel through mechanical seals or packing gland seals 120 and 121. These seals serve to contain the polymer flow and gases allowing the development of pressure or vacuum without un-wanted leakage from the expansion housing to the atmosphere.

The barrel housings 117, 118 and 119 are rigidly attached to the gear reduction unit through the seal housing 122, 123 and 124 and the lantern section 125, 126 and 127. The lantern section allows access for de-coupling the extruder screws from the gear reduction units. The lantern section may be water cooled with an internal water course 128 to reduce heat flow from the barrel to the gear reduction unit.

The extruder barrels may be equipped with external heating supplied by steam, hot oil or electric resistance heaters. The barrels may also be equipped with access ports along the length of the screw shafts for the introduction of liquids or solids or the atmospheric or vacuum removal of liquids or volatile fractions as required by the specific polymer chemistry. The polymer enters extruder A in the inlet and driven end feed port 129. During operation, various mixing, shearing and conveying screw designs process the polymer and any additives and reactants as is common to the art and specific to the reactions desired. As the polymer proceeds from the input of the first extruder 129 to the final output of the final connected extruder at 130, variously located heating and cooling devices may be attached to or included within the extruder barrels to add or remove heat as required by the specific polymer chemistry. Final output of the extruder assembly is through the outlet end of the last connected extruder at 130 through devices appropriate for pumping, cooling and packaging of the polymer as are familiar to those experienced in the art.

The rotation of the screws and the external heat sources supply the energy to melt the polymer. The barrel temperatures may increase from ambient to greater than 400° C. The thermal expansion along the axes of the barrels of an extruder of 4 meters in length may exceed 20 mm, and each extruder in the disclosed assembly operates independently and thus may expand in differing lengths, from 0 to greater than 20 mm per 4 meters. As the barrels are rigidly connected to the base or pad via the seal housings, lantern sections and the gear reduction units, the barrels must expand linearly away from the individual driven ends toward the respective individual outlet ends. On cooling, the barrels independently reverse the linear thermal expansion and contract away from the outlet ends toward the driven or inlet ends.

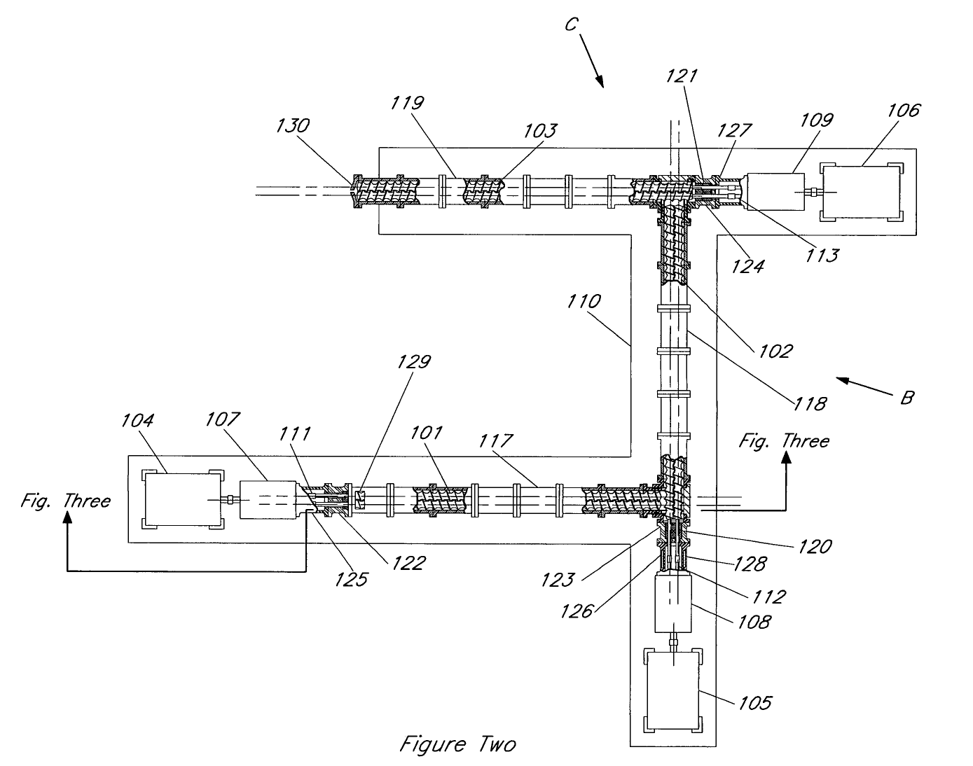

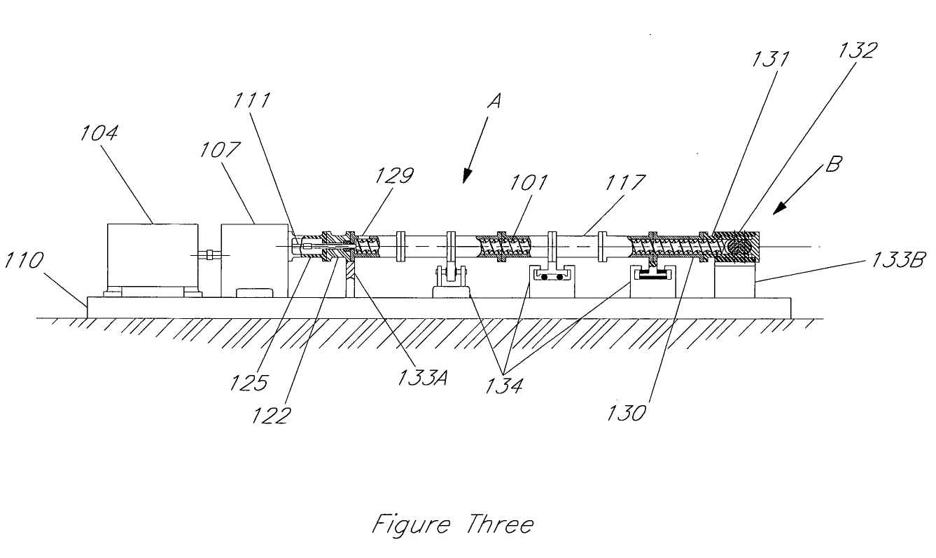

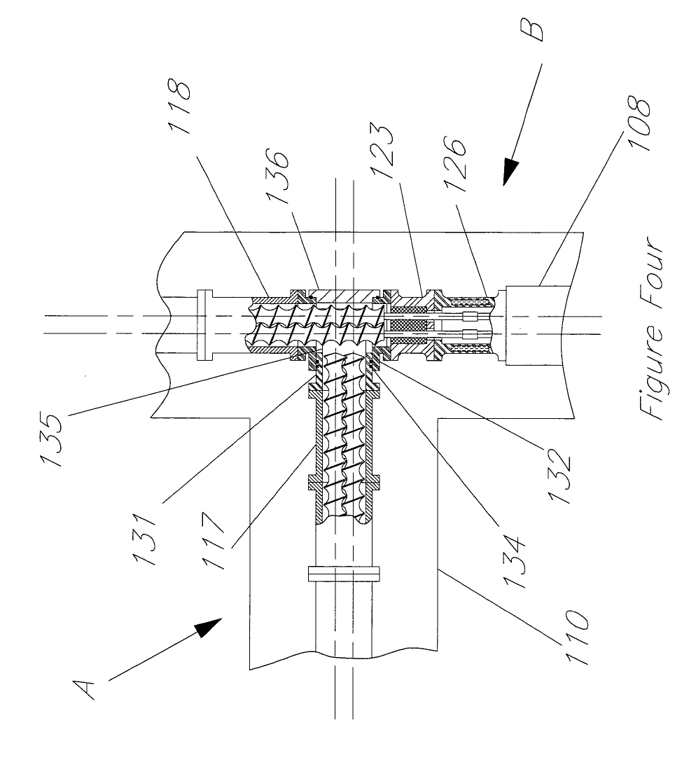

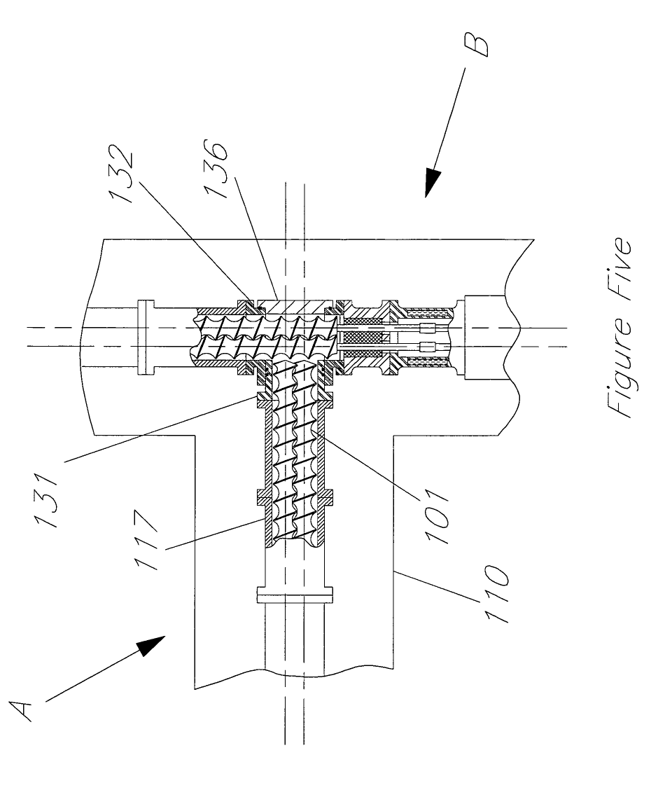

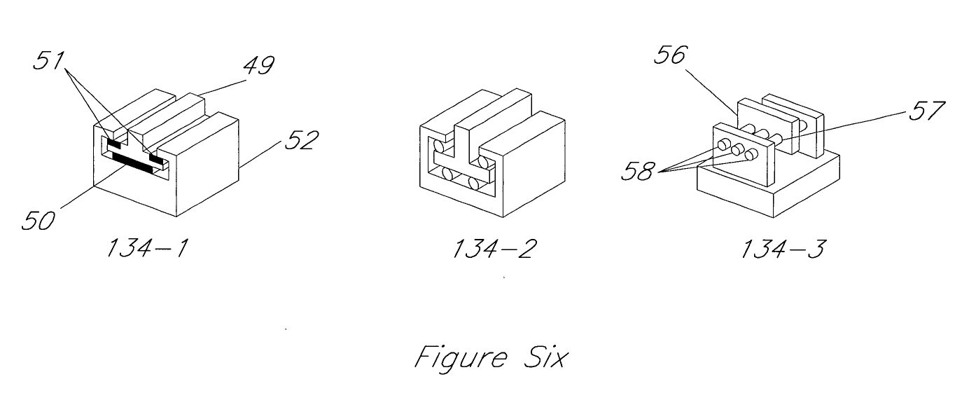

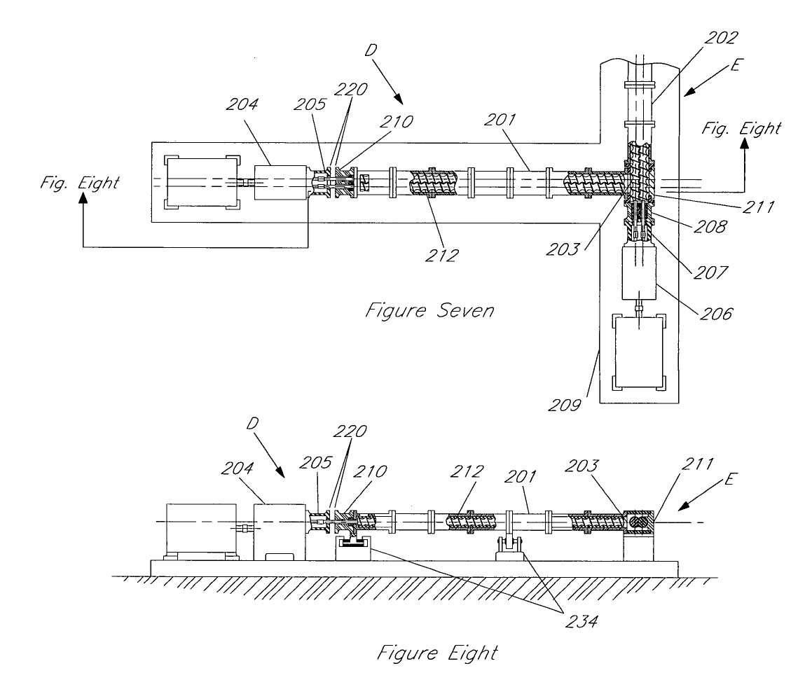

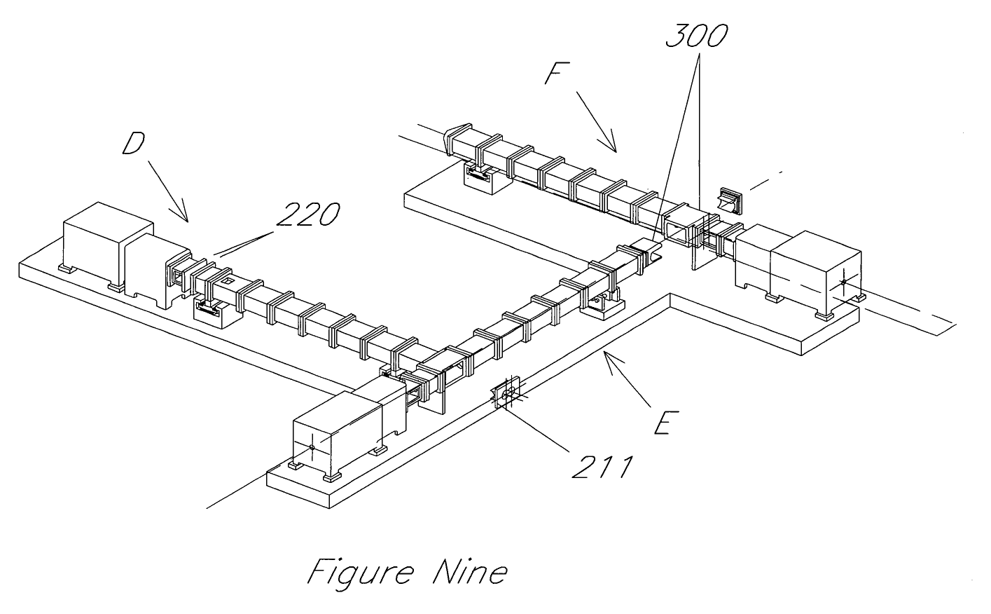

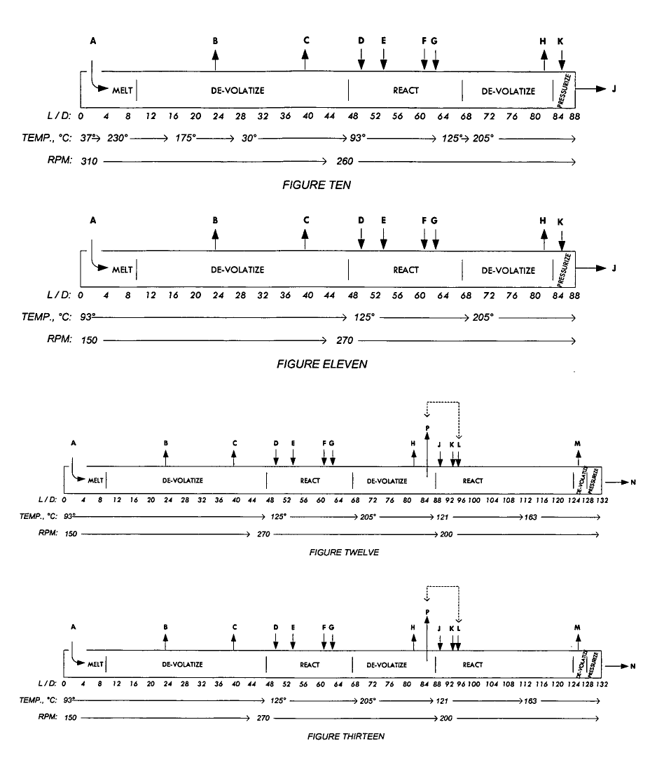

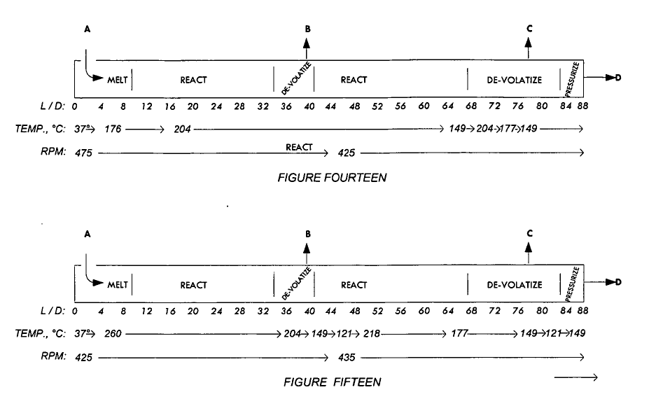

The expansion and contraction of the sequential extruder barrels is accommodated with a unique transition connection assembly between connected extruders. Reference is made to Figure Three, the elevation and partial cut away section of FIG. 2. The input end of barrel 117 of extruder “A” is rigidly connected to the seal housing 122 and lantern section 11 1. The lantern section 111 is rigidly connected to the gear reduction unit 107 that is rigidly connected to the base pad 1 10. The input end of barrel 1 17 is also attached and supported rigidly to the base 1 10 via the fixed support 133A. The remainder of barrel 117 of extruder A is supported longitudinally along the barrel by a multiple of low friction, linear mountings 134. These linear mountings are aligned so as to prevent any rotational movement of the extruder barrel 117 about any axis and to allow linear motion only parallel to the axis of the extruder shaft 101 and thus parallel to the extruder barrel 117.

The outlet of the extruder barrel 117 of upstream extruder “A” abuts and is rigidly attached to expansion piston 131. The piston is free to slide within the expansion piston housing 132. The piston housing is rigidly attached to the downstream extruder “B” via seal housing 132. Seal housing 132 is rigidly mounted to the base 110 via the rigid support 133B.

Reference is made to Figure Four, the partial cut away and expanded detail plan of the upstream extruder “A” and downstream extruder “B” connection in the ambient temperature state. Extruder “A” barrel 117 is rigidly attached to the expansion piston 131. The piston housing 132 is rigidly attached to the upstream extruder “B” seal housing 123 and thus the downstream extruder “B” lantern housing 123 and thus to the downstream extruder “B” gear reduction unit 108 and thus the common assembly base plate 110. The piston housing is also rigidly attached to the downstream extruder “B” barrel 118. The piston is variously equipped with a series of ring grooves and elastomeric ring seals 134. The clearance of the expansion piston 131 within the expansion piston housing 132 is sufficient to allow free movement of the piston 131 but tight enough to prevent leakage of polymer or gases. As the upstream extruder “A” barrel 117 expands linearly away from the upstream extruder “A” driven and input end and toward the outlet end, the upstream extruder “A” barrel 117 moves the expansion piston 131 across the expansion piston housing 132. The piston 131 closes the space 135 provided for its movement and stops just near the piston housing cap 136.

Reference is made to Figure Five, the partial cut away and expanded detail plan of the upstream extruder “A” and downstream extruder “B” connection in the operating or elevated temperature state, or after the upstream extruder A barrel 117 and up stream extruder A screw shafts 101 have expanded longitudinally. The leading edge of the piston 131 now abuts the piston housing cap 136. The piston housing cap 136 can be removed to allow removal of the upstream extruder shafts 117 through the piston 131 and piston housing 132. The piston housing cap 136 may also be bored to allow controlled entry or removal of liquids, gases, solids or polymers during operation.

On cooling, the up stream extruder “A” barrel 117 and shafts 117 contract and return to the position shown in Figure Four. This also returns attached expansion piston 131 to its original position shown in Figure Four. This connection is applicable to each extruder connection.

Reference again is made to Figure Three. The extruder barrels are free to expand longitudinally from the inlet end and are supported by the base plate 110 on a multiple of low friction mountings 134. These mountings allow movement only along the longitudinal or long axes of the extruder barrels. Rotational movement about any axis is restrained as is any barrel movement perpendicular to the long axis of the barrel. Reference is made to Figure Six Three distinct extruder barrel mountings 134-1, 134-2 and 134-3 are shown. In practice, any combination of these types may be used to support the extruder barrel. The slide friction mounting 134-1 consists of an attachment leg bearing pad 49 rigidly attached to the extruder barrel and that slides on and is restrained by low friction bearing surfaces 50 and 51 enclosed in the mounting housing 52. As an alternative, the low friction bearing pads can be replaced by rollers as in 134-2. The rod mounting 134-3 consists of an attachment leg and guide 56 rigidly attached to the extruder barrel. The attachment leg 56 is drilled and sleeved 57 to ride along the axes of multiple linear polished shafts 58. All mountings completely restrain rotation of the mounted extruder barrel on all axes and allow linear movement of the extruder barrel only in a direction parallel to the extruder barrel.

While the previously described piston and piston housing connection assembly will also serve to connect any number of sequential machines, an alternative connection assembly is also proposed for the specific connection between the first extruder and the second extruder only of a series of two or more extruders. Reference is made to Figure Seven and Figure Eight, elevation and partial cross-section of Figure Seven. The barrel 201 of the first extruder “D” is rigidly attached to the second extruder “E” barrel housing 202 through an opening window 203 located at the inlet end of the second extruder “E”. The first extruder “D” barrel 201 is not connected to the first extruder “D” gear reduction unit 204 or first extruder “D” lantern housing 205 and thus the feed section of extruder “D” is not rigidly attached to the base plate 209. The second extruder “E” barrel 202 is rigidly connected to the second extruder “E” gear reduction unit 206 through the second extruder “E” seal housing 208 and thus the second extruder “E” lantern housing 207. The second extruder “E” gear reduction unit 206 is rigidly connected to the base plate or pad 209. Access to remove the first extruder “D” screw shaft pair 212 from the first extruder “D” barrel housing 201 is provided by removable plug 211 on the second extruder “E” barrel housing 202. The removable plug may also be bored to allow controlled entry or removal of liquids, gases, solids or polymers during operation. The inlet end of second extruder “E” is sealed at all locations. Figure Eight details the support for the barrel housing 212 of Extruder “D”. The support connections 234 are identical in design and operation as those described previously in Figure Six. As first extruder “D” is heated, the first extruder “D” barrel housing 201 expands linearly away from the connection 203 at the second extruder “E”. This expansion is accommodated by the gap 220 provided between the first extruder “D” lantern section 205 and the first extruder “D” seal housing 210. The first extruder “D” screw shafts 212 are rigidly attached to the first extruder “D” gear reduction unit 204 and thus expand linearly toward the second extruder “E”. The shaft lengths are selected such that on heating each from ambient to the required operating temperatures, the individual shafts expand longitudinally and extend just to but not intersecting with the flights of the sequential extruder shaft flights.

Reference is made to Figure Nine. The isometric detail of a multiple extruder assembly “D” “E” and “F” is shown using the rigid connection method at the intersection of the first extruder “D” with the second extruder “E” and the piston connection method at the connection of second extruder “E” with third extruder “F”. The expansion gap 220 is provided for extruder “D” and the piston and piston housing 300 is provided for the connection of extruder “E” and “F”. The connection housing plug 211 is shown bored to accept feed assembly as is common to the art.

Operation of each extruder in the multiple extruder assembly is performed through separate and independent control and drive systems. Each extruder can thus rotate at equal or differing screw revolutions per minute.

### DETAILED DESCRIPTION OF THE PROCESSES

As the disclosed assembly may accommodate large values of extruder length to diameter ratios, multiple rpm settings and is able to permit a continuous, uninterrupted series of stirred, melt phase polymer reactions and processes, it may be economically employed to produce a wide range of reacted and modified polymers.

### EXAMPLE ONE

Reference is made to Figure Ten. An ethylene-propylene copolymer rubber with 49 weight % ethylene, 50 Mooney viscosity measured at 100° C. (ML 1+4) and a moisture content of less than 2.0% is ground to an average particle size of approximately 0.25″diameter and fed into the feed zone “A” of a multiple twin screw extruder assembly with total length to diameter ratio, L/D, of 88 to 1 and screw diameter of 92 mm. The feed rate is 2,000 pounds per hour. Each of the coupled extruders is powered by a 700 horsepower motor. The RPM for L/D 0 to 44 is set at 310. The RPM for L/D 45 to 88 is set at 260. The barrel temperatures in ° C. are set as indicated in Figure Ten. Vacuum is pulled from “B”, “C” and maintained at greater than 18 inches of mercury.

The discharge of the first extruder is fed into the second extruder that is serially connected to the first extruder with no un-mixed, uncontained or unregulated temperature zone between the two extruders. Rubber entering the second extruder at L/D of 44 has a moisture content of less than 0.06% and the Mooney viscosity essentially unchanged vis-à-vis the feed-stock rubber. Molten maleic anhydride is injected in locations “D” and “F” at equal rates of 27.5 lbs/hr each. Lastly, 2,5-dimethyl-2,2-di(tertiary-butyl peroxy)hexyne-3 is injected in locations “E” and “G” at equal rates of 2.5 lbs/hr. A vacuum of a minimum of 21 inches of mercury is pulled on location “H”. The final product at “J” is pelletized and has volatile content less than 0.1%, a melt Index (ASTM D-1238, 1900 C, 2160 grams.) of 4.5 grams/10 minutes and a grafted maleic anhydride=1.85%.

The long L/D provided by the multiple extruder assembly allows for lower temperatures of the de-volatized rubber and longer, lower temperature reaction zones. The primary benefit of this process is a greatly reduced gel count. Samples of the product are dissolved in tetra-hydro furan at a ratio of 50 to 1 for 120 minutes. Samples are filtered through a 350 mesh screen and weight percentage of the residual, un-dissolved rubber is determined. Material processed using the long, 88:1 L/D multiple extruder assembly has un-dissolved rubber fractions of less than 0.05%.

Optionally, solvent neutral oil is injected and mixed in location “K” to facilitate downstream amine capping in solution.

### EXAMPLE TWO

Reference is made to Figure Eleven. A polymer cement exiting a thin film evaporator is fed at the rate of 2,500 lbs/hr is fed into the feed zone “A” of a multiple twin screw extruder assembly with total length to diameter ratio, L/D, of 88 to 1 and screw diameter of 92 mm. Each of the coupled extruders is powered by a 700 horsepower motor. The RPM for L/D 0 to 44 is set at 150. The RPM for L/D 45 to 88 is set at 270. The barrel temperatures in ° C. are set as indicated in Figure Eleven. Vacuum is pulled from “B”, “C” and maintained at greater than 21 inches of mercury. The polymer cement feedstock has the following characteristics: weight % n-hexane=20%; weight % ethylene/propylene copolymer=80%. The ethylene/propylene copolymer has the following characteristics: weight % ethylene=49%; Mooney viscosity (ML1+4@ 1000 C)=50

The discharge of the first extruder is fed into the second extruder that is serially connected to the first extruder with no un-mixed, uncontained, or unregulated temperature zone between the two extruders. Rubber entering the second extruder has a volatile content of less than 0.06% and the Mooney viscosity essentially unchanged vis-a-vis the feed-stock rubber.

Molten maleic anhydride is injected in locations “D” and “F” at equal rates of 27.5 lbs/hr each. Lastly, 2,5-dimethyl-2,2-di(tertiary-butyl peroxy) hexyne-3 is injected in locations “E” and “G” at equal rates of 2.6 lbs/hr. A vacuum of a minimum of 24 inches of mercury is pulled on location “H”. The final product at “J” is pelletized and has volatile content less than 0.06%, a melt Index (ASTM D-1238, 1900 C, 2160 grams.) of 5.5 grams/10 minutes and a grafted maleic anhydride=2.0%.

The long L/D provided by the multiple extruder assembly allows for lower temperatures of the de-volatized rubber and longer, lower temperature reaction zones. The primary benefit of this process is a greatly reduced gel count. Samples of the product are dissolved in tetra-hydro furan at a ratio of 50 to 1 for 120 minutes. Samples are filtered through a 300 mesh screen and residual, un-dissolved rubber weight is determined. Material processed using the long, 88:1 L/D multiple extruder assembly has un-dissolved rubber fractions of less than 0.04%.

Optionally, solvent neutral oil can be injected and mixed in location “K” to facilitate downstream amine capping in solution.

### EXAMPLE THREE

Reference is made to Figure Twelve. The process is the same as Example 1, except the following: The product exiting the second extruder is then continuously fed into a third extruder that is serially connected to the second extruder wherein no unmixed, uncontained or temperature unregulated zone between the second and third extruders exists. The output of the second extruder is monitored by an embedded FTIR probe and control loop at location “P”. The third extruder is a 700 horsepower, 44/1 L/D, and 92 mm twin-screw extruder. The extruder RPM and temperatures are as shown in Figure Eleven.

Solvent neutral oil is pumped into locations “J” and “K” at the rate of 500 lbs/hr each. Molten N-phenyl para-phenylene diamine is injected in location “L” at the rate of approximately 70 lbs/hr as controlled by said FTIR probe at “P”. A vacuum of at least 24″ of mercury is pulled at location “M” to remove the water of reaction. The output of the third extruder is collected as a liquid in drums at “N”.

The finished product of this example is an oil concentrate of maleated and amine capped ethylene/propylene copolymer. The nitrogen bound to the polymer is 0.53%. The polymer concentrate can be optionally further diluted with additional solvent neutral oil to a desired final polymer content.

### EXAMPLE FOUR

Reference is made to Figure Thirteen. The process is the same as Example 2, except the following: The product exiting the second extruder is then continuously fed into a third extruder that is serially connected to the second extruder wherein no unmixed, uncontained or temperature unregulated zone between the second and third extruders exists. The output of the second extruder is monitored by an embedded FTIR probe and control loop at location “P”. The third extruder is a 700 horsepower, 44/1 L/D, 92-mm twin-screw extruder. The extruder RPM and temperatures are as shown in Figure Eleven.

Solvent neutral oil is pumped into locations “J” and “K” at the rate of 500 lbs/hr each. Molten N-phenyl para-phenylene diamine is injected in location “L” at the rate of approximately 77 lbs/hr as controlled by said FTIR probe at “P”. A vacuum of at least 24″ of mercury is pulled at location “M” to remove the water of reaction. The output of the third extruder is collected as a liquid in drums at “N”.

The finished product of this example is an oil concentrate of maleated and amine capped ethylene/propylene copolymer. The nitrogen bound to the polymer is 0.59%. The polymer concentrate can be optionally further diluted with additional solvent neutral oil to a desired final polymer content.

### EXAMPLE FIVE

Reference is made to Figure Fourteen. Ethylene acrylic acid (EAA) co-polymer pellets with a melt index of 35 grams per 10 minutes at 190° C., 2160 grams per ASTM D1238 and with an acrylic acid content per ASTM D4094 of 8.7 weight % and sodium carbonate powder are fed into feed zone “A” of a multiple twin screw extruder assembly with total length to diameter ratio, L/D, of 88 to 1 and screw diameter of 92 mm and constructed of hardened carbon steel. The feed rate is 1,500 pounds per hour of EAA and 50 pounds per hour of sodium carbonate. Each of the coupled extruders is powered by a 700 horsepower motor. The RPM for L/D 0 to 44 is set at 475. The RPM for L/D 45 to 88 is set at 425. The barrel temperatures in ° C. are set as indicated in Figure Fourteen. Vacuum is pulled from “B”, “C” and maintained at greater than 22 inches of mercury. The product exits the assembly at “D”. The final product melt index is 1.2 grams per 10 minutes with free volatiles less than 0.04%. Gel rating is performed on an Optical Control Systems, GmbH, model FT Film Scan Testing System. Gel count and diameters are measured to be fewer than 900 0.2 mm, fewer than 70 0.3 mm, fewer than 51 0.4 mm and fewer than 37 0.6 mm, fewer than 4 0.8 mm and no more than 1 greater than 0.8 mm observed in 1.145 square meters.

The multiple extruder continuous process assembly provided by the disclosed equipment herein allows for sufficient reaction time to completely react the sodium carbonate with the acid functionality of the EAA. Prior art uses sodium hydroxide, but at elevated temperatures, sodium hydroxide requires the extruder assembly to be constructed of exotic and expensive corrosion resistant alloys. Prior art using sodium carbonate employs high temperatures, often greater than 250° C. causing the increased formation of degraded or gelled final product.

### EXAMPLE SIX

Reference is made to Figure Fifteen. Ethylene acrylic acid (EAA) co-polymer pellets with a melt index of 60 grams per 10 minutes at 190° C., 2160 grams per ASTM D1238 and with a 13.5 weight % acrylic acid content per ASTM D4094 and zinc oxide powder are fed into feed zone “A” of a multiple twin screw extruder assembly with total length to diameter ratio, L/D, of 88 to 1 and screw diameter of 92 mm and constructed of hardened carbon steel. The feed rate is 2,000 pounds per hour of EAA and 23 pounds per hour of zinc oxide. Each of the coupled extruders is powered by a 700 horsepower motor. The RPM for L/D 0 to 44 is set at 475. The RPM for L/D 45 to 88 is set at 425. The barrel temperatures in OC are set as indicated in Figure Fifteen. Vacuum is pulled from “B”, “C” and maintained at greater than 22 inches of mercury. The product exits the assembly at “D”. The final product melt index is 14 grams per 10 minutes with free volatiles less than 0.04%. Gel rating is performed on an Optical Control Systems, GmbH, model FT Film Scan Testing System. Gel count and diameters are measured to be fewer than 900 0.2 mm, fewer than 70 0.3 mm, fewer than 51 0.4 mm and fewer than 37 0.6 mm, fewer than 4 0.8 mm and no more than 1 greater than 0.8 mm observed in 1.145 square meters.

The multiple extruder continuous process assembly provided by the disclosed equipment herein allows for sufficient reaction time to completely react the zinc with the acid functionality of the EAA. Prior art uses sodium hydroxide, but at elevated temperatures, sodium hydroxide requires the extruder assembly to be constructed of exotic and expensive corrosion resistant alloys. Prior art using sodium carbonate employs high temperatures, often greater than 250° C. causing the increased formation of degraded or gelled final product.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A multiple extruder reactor apparatus for modifying in the melt state the chemical, rheological or chemical and rheological properties of a polymer or polymers that comprises in combination:
a. two or more extruders serially connected such that the output of each extruder flows directly into the feed zone of the next extruder and such that the polymer modification and transport process in the connected extruder assembly is continuous from one extruder to the next;
b. an assembly of mechanical connections and seals between the inter-connected extruders such that no un-stirred, un-contained or unregulated temperature or pressure region exists between any two so connected extruders or anywhere along the flow path of the polymer melt;
C. an assembly of mechanical connections between the multiple individual extruders and a single continuous supporting base plate or pad such that the thermal expansion and contraction of all extruder barrel and screw assemblies is not restrained along the axis of the extruder barrel and such that all rotational movement of the extruder barrels is restrained;
d. separate and independently controlled drive motors and gear reduction assemblies for each extruder allowing for equal or differing screw rpm's in each extruder during operation;
e. a vertical side mounted access port on the connecting zone of the downstream extruders directly opposite to the entry location of the screw shafts of the upstream extruders for the removal of the upstream extruder screw shafts and the addition or removal of liquids, solids or gases during operation; and
f. multiple ports located anywhere along the extruder apparatus for the addition or removal of liquids, solids or gases.

2. An apparatus according to claim 1 wherein said extruders are twin-screw extruders.

3. An apparatus according to claim 1 wherein said extruders are of differing or equal length or diameter.

4. An apparatus according to claim 1 wherein said extruders have individual screw length to diameter ratios greater than 1 to 1 and more preferably 68 to 1 and most preferably 44 to 1.

5. An apparatus according to claim 1 wherein each said extruder is independently capable of chemical, rheological, or chemical and Theological modifications to polymers.

6. An apparatus according to claim 1 such that the axes of the barrels and screw shafts of the connected extruders are perpendicular to and co-planer with the axes of the barrels and screw shaft of each other sequentially connected extruder and the discharge end of the up stream extruder barrel is rigidly attached to a piston that in turn when the barrel is heated or cooled slides through a piston housing. Said piston housing is also the feed region of the connected downstream extruder with the screw shafts of the upstream extruder extended through the piston and the screw tips of the upstream extruder when heated extending up to the edges of the flights of the screws in the downstream extruder so to eliminate any length or region of the combined extruder assemblies flow path wherein the polymer flow is un-stirred or subject to un-regulated temperature control and more specifically not uniformly mixed, cooled, or heated.

7. A seal assembly on the piston according to claim 6 so as to allow for either high vacuum or high pressure to be present in the piston housing of claim 6.

8. An apparatus according to claim 1 wherein the feed region of the downstream extruders are mechanically sealed at the entry points of the screw shafts of the so as to allow for either high vacuum or high pressure to be present in the entirety of the combined extruders length without unintended leakage from or to the atmosphere into any region.

9. An apparatus according to claim 7 and claim 6 wherein high vacuum is a vacuum greater than 27.0 inches of mercury and a high pressure is pressure up to 69.0 bar.

10. An apparatus according to claim 6 wherein the extruder barrels are each rigidly connected to the common base plate at the feed zone of each extruder via rigid connections to the extruder gear reduction unit and further supported along each horizontal axis on multiple horizontal slide mountings placed between the extruder barrels and the base plate.

11. An apparatus according to claim 10 wherein the barrel of the downstream extruders are rigidly connected to the gear box through a lantern frame connection that is cooled to reduce heat flow to the gear box from the extruder barrel.

12. A slide mechanism according to claim 10 wherein the mounting consists of a rigid “ell” or “tee” shaped plate attached to the extruder barrel and being supported by a multiple of linear sleeve guide bearings, rollers, or low friction bearing pads and mounted so as to restrict all movements to those that are linear and parallel to the axis of the mounted extruder barrel and shafts.

13. An apparatus according to claim 1 wherein the outlet end of only the first extruder is rigidly connected to the feed zone of the second extruder and the barrels of the first extruder are not otherwise rigidly connected to the base plate via the first extruder gear reduction unit but are supported axially along the extruder barrel length by multiple horizontal slide mountings placed between the extruder barrels and the base plate.

14. A slide mechanism according to claim 13 wherein the mounting consist of a rigid “ell” or “tee” shaped plate attached to the extruder barrel and being supported by a multiple of linear sleeve guide bearings, rollers, or low friction bearing pads and mounted so as to restrict all movements to those that are linear and parallel to the axis of the mounted extruder barrel and shafts.

15. A process wherein apparatus disclosed in claim 1 is used to graft one or more chemical constituents to and to optionally simultaneously or sequentially modify the viscosity of, add minerals, polymers, or solvents to, remove volatiles from, or substantially change the temperature of or perform a combination of any or all of these to the grafted or pre-grafted polymer melt.

16. Same as claim 15 wherein the polymer is an olefinic homo-polymer, copolymer or terpolymer.

17. Same as claim 16 wherein the chemical constituent is selected from the group consisting of di-carboxylic acids and their derivatives, such as esters and anhydrides and the graft to a homo-polymer and co-polymer is imparted in the presence of a free radical initiator and to a terpolymer in the absence of a free radical initiator.

18. Same as claim 17 wherein the copolymer is an ethylene/propylene copolymer and the terpolymer is ethylene/propylene/polyene terpolymer.

19. Same as claim 18 wherein the polymer undergoes de-watering followed by melt viscosity reduction.

20. Same as claim 19 wherein the melt viscosity reduction is preceded, succeeded or accompanied by graft functionalization with a carboxylic compound.

21. Same as claim 20 wherein the carboxylic compound is maleic anhydride and the free radical initiator is selected from one or more of organic peroxides including diacyl peroxides, dialkyl peroxides, hydroperoxides, peroxydicarbonates, peroxyesters, peroxyketals and more preferably di-tertiary butyl peroxide, 2,5-dimethyl-2,5 di(tertiary butyl peroxy)hexane and 2,5-dimethyl-2,5 di(tertiary butyl peroxy)hexyne-3.

22. Same as claim 21 wherein the final product has an insoluble content of less 0.1 weight % when dissolved in tetra hydro furan.

23. Same as claim 21 wherein the process is further continued to include capping of the anhydride functionality.

24. Same as claim 23 wherein the capping agent is selected from one or more of the following: N-phenyl para-phenylene diamine, N-arylphenylene diamines, aminocarbazoles, aminoindoles, amino-indazolinones and aminomercaptotriazoles

25. Same as claim 21 wherein the process is continued to include dissolving the product in a solvent neutral oil to facilitate downstream amine capping reaction.

26. Same as claim 21 wherein the ethylene propylene copolymer is fed to the first extruder as a solution in an aliphatic hydrocarbon solvent.

27. Same as claim 25 wherein the process is further continued to include amine capping of the anhydride functionality.

28. Same as claim 25 wherein the process is continued to include dissolving the product in a solvent neutral oil to facilitate downstream amine capping reaction.

29. A process wherein apparatus disclosed in claim 1 is used to neutralize an acid functional copolymer.

30. Same as claim 29 wherein the acid functional copolymer is an olefin/multi-functional organic acid co-polymer including ethylene acrylic acid copolymer and ethylene methacrylic acid co-polymer and the neutralizing agent is one or more basic alkali metal salts alone or in combination.

31. Same as claim 29 wherein the acid functional copolymer is an ethylene/acrylic acid copolymer and the neutralizing agent is zinc oxide.

32. Same as claim 30 wherein the basic alkali metal salt is sodium carbonate.

33. Same as claim 32 wherein use of alkali metal salt facilitates neutralization at significantly lower temperature than that necessary with the corresponding alkali metal hydroxide thereby resulting in a product with significantly reduced gel content and negating the need to use exotic and expensive corrosion resistant materials for the construction of the reactive extrusion apparatus.

34. Same as claim 29 wherein the neutralized acid copolymer has a total gel count of less than 1,100 gels per 1.15 square meters of which fewer than 900 gels are of 0.2 mm diameter, fewer than 70 gels are of 0.3 mm diameter, fewer than 51 gels are of 0.4 mm diameter, fewer than 37 gels are of 0.6 mm diameter, fewer than 4 gels are of 0.8 mm diameter and no more than 1 gel greater than is of 0.8 mm diameter observed in 1.15 square meters as measured and counted on an Optical Control Systems, GmbH, model FT Film Scan Testing System.

35. A process wherein apparatus disclosed in claim 1 is used to combine processes disclosed above in claim 15 and claim 29.
